(19) United States
(12) Patent Application Publication
(10) Pub. No.: US 2015/0175104 A1
(43) Pub. Date: Jun. 25, 2015

(54) ENERGY HARVESTING FOR THE ELECTRONIC REGULATION OF OXYGEN FLOW

(71) Applicant: B/E Aerospace, Inc., Wellington, FL (US)

(72) Inventors: Andrew Elliott, Shawnee, KS (US); Duane Davis, Wichita, KS (US); Kevin Booze, Wichita, KS (US)

(21) Appl. No.: 14/570,695

(22) Filed: Dec. 15, 2014

Related U.S. Application Data
(60) Provisional application No. 61/918,910, filed on Dec. 20, 2013.

(51) Int. Cl. B60R 16/033; A62B 7/14; H02J 7/34; A62B 9/00

(52) U.S. Cl. CPC B60R 16/033; A62B 9/00; A62B 7/14; H02J 7/34

(57) ABSTRACT

A method and system for powering an oxygen regulation, metering, or control device for an aircraft's emergency oxygen supply system. A passenger safety unit includes a flow control device connected to a supply of oxygen, and an energy harvesting device that converts waste energy to electrical energy that may be stored in an energy storage device. The control of the oxygen flow is powered using the energy storage device using electrical energy obtained from the waste energy.

### CROSS-REFERENCES TO RELATED APPLICATIONS

This application claims priority from U.S. Provisional Patent Application No. 61/918,910, filed Dec. 20, 2013, the content of which is incorporated herein by reference in its entirety.

### BACKGROUND

The present invention relates generally to a method of powering an oxygen supply/regulation system for an emergency supply of oxygen in an aircraft, as well as an energy harvesting and storage apparatus for detection or control of said oxygen regulation system.

Oxygen systems, like many gas supply systems, are used extensively in many different fields, including medical, industrial, commercial, and particularly in the field of transportation. For example, when depressurization occurs inside of an airplane at high altitude, the level of oxygen drops drastically. In this event, aircraft are equipped with an emergency system to supply the necessary oxygen to sustain passenger demand while the airplane descends to lower altitudes until artificial methods of oxygen supply are no longer needed. The oxygen that has to be carried to supply passenger demand under this situation is limited, and for that reason the industry is always striving for a more efficient method of supplying emergency oxygen supply using an oxygen regulation system.

In the above-described example, oxygen regulation systems that intermittently release the gas (specifically, pulse or saturation based systems) improve the efficiency of oxygen supply to the passenger. These systems require less oxygen be stored onboard, which in turn translates to less fixed weight for the aircraft and lower costs. Moreover, pulse systems are passive systems that only use power when the breathing cycle is initiated. That is, each breath cycle is supplied with a small oxygen dose and the presence of oxygen flow is indicated by an illuminated signal. The continuous need for weight reduction in the emergency oxygen supply system of an aircraft, and the limits on power supply system extra fuel needed during emergency situations, continue to call for more efficient ways of powering aircraft components in general and oxygen supply systems in particular. The present invention addresses this need by utilizing environmental or residual energy from the aircraft surroundings to power the oxygen metering/regulation system.

U.S. Pat. No. 7,298,280 to Voege, et al., entitled “Lighted Fluid Flow Indication Apparatus”, the contents of which are incorporated herein by reference, discloses an indicator for an oxygen supply tube that provides a visual, audible or other indication when gas is flowing through a tube, when the tube has been disconnected from a supply, or when pressure in the tube has dropped below a predetermined level due to a leak or pressure drop in the gas supply.

### SUMMARY OF THE INVENTION

Aircraft, like any other vehicle, have multiple electrical and mechanical components, and the constant operation of these devices generates unused “waste” energy in the form of vibrations, heat, and light. The present invention is an energy harvesting device that converts this waste energy into electricity, which can then be reused in the aircraft, such as in the oxygen supply system. The waste energy harvesting system of the present invention reduces the total weight from the aircraft by eliminating the need for extra power lines inside the airplane, since the energy harvester may be located in close proximity to each oxygen delivery station, also referred to as a “Passenger Service Unit” (or PSU). Having an independent storage of energy for each PSU system could free up resources the aircraft could use in an emergency situation, including the failure of traditional aircraft power sources.

The present invention includes an energy harvesting device, which may be located in close proximity with a PSU. The energy harvesting device can include piezoelectric converters, photovoltaic converters, thermoelectric converters, or other such energy converting devices that convert waste energy such as vibration, heat, or light, to storable electrical energy. Depending upon the type of energy harvesting device, vibration/photonic/thermal energy from the surroundings inside the aircraft is converted into electrical charge, which in turn is converted into direct current by a controller board and an electrical energy storage device (battery, capacitor, fuel cell). The energy storage device is selected to have the capability to store a charge of sufficient magnitude to power the PSU target system, be it an oxygen pulse system, signal/alarm generating system, etc.), without the need to be charged previously by the energy harvesting device. In case of an emergency that requires immediate oxygen supply, the stored charge can immediately and sufficiently operate the system without pre-charging or supplemental power. Thus, the energy harvesting device maintains a charge on the energy storage device for the entire flight and the system is always active with no secondary power supply requirements. When an unexpected loss in cabin pressure occurs, a sensor detects the pressure drop and sends a signal to the controller board of the PSU to initiate activation of the system. The door containing the oxygen mask will open via an opening mechanism, and oxygen will begin to flow through the mask, where each electrical device is powered by energy stored in the energy storage device.

Other features and advantages of the present invention will become more apparent from the following detailed description of the preferred embodiments in conjunction with the accompanying drawing, which illustrates, by way of example, the operation of the invention.

### BRIEF DESCRIPTION OF THE DRAWINGS

FIG. 1 is a schematic drawing of an energy harvest system for an oxygen supply system.

### DETAILED DESCRIPTION OF THE PREFERRED EMBODIMENTS

While the present invention is described in the environment of passenger oxygen supply systems, the invention is not limited to this application and can serve many functions relating to aircraft subsystems that require infrequent or intermittent low demand electrical power. Thus, the invention is properly construed to cover a wide array of energy systems that can benefit from the present invention.

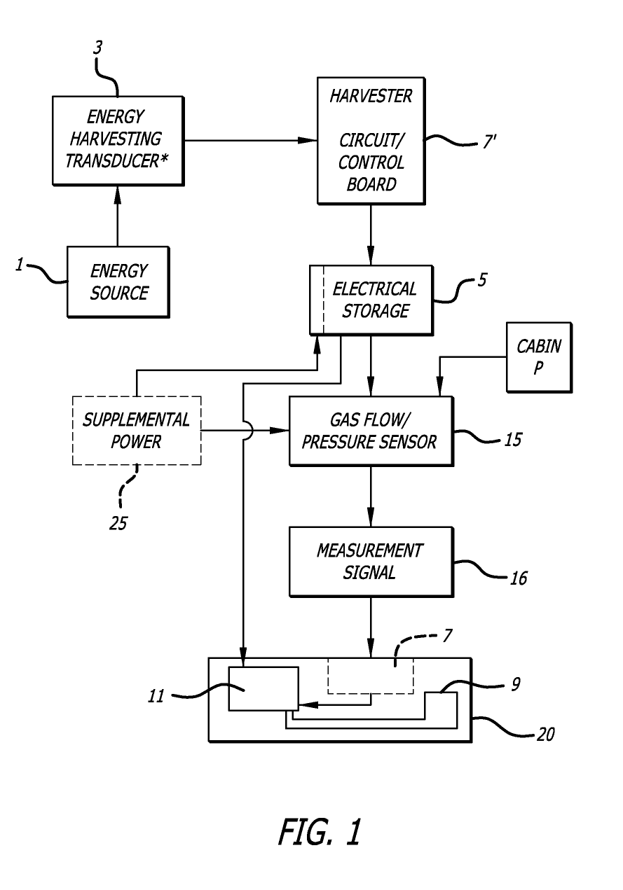

FIG. 1 illustrates an energy harvest system for supplying power to a passenger oxygen delivery station on an aircraft. The energy harvest system utilizes environmental energy such as vibration, heat, light, or the like, and converts this “waste” energy to stored electrical energy. An energy harvester device 3, which can be piezoelectric, photovoltaic, thermoelectric, etc., is located in proximity with an energy client such as a PSU, which may be stored above a passenger's seat on the aircraft. The energy harvester device 3 converts vibration/photonic/thermal energy 1, depending upon the type of converter, from the surroundings into an electric charge. A vibration energy harvester operates such that the mechanical energy (e.g., applied external force or acceleration) is converted into mechanical energy in a host structure. The latter is then converted into electrical energy by a piezoelectric element, and is finally transferred in electrical form to a storage device. Photovoltaic devices convert impinging light into electrical energy, which is then stored in an electrical storage device. Thermoelectric converters convert ambient heat to electrical energy which can be stored in an electrical storage device, such as those disclosed in U.S. Pat. No. 6,787,691 to Fleurial, et al., entitled “Microfabricated Thermoelectric Power-Generation Devices,” the contents of which are incorporated herein by reference.

The electrical charge generated by the harvesting device 3 is then converted to a direct current by an energy harvesting controller board 7′, which in turn is used to charge an energy storage device 5 such as a battery, capacitor, or fuel cell. The energy storage device 5 is selected to collect and hold a charge large enough to power the PSU target systems (e.g., oxygen pulse, signal, sensor, alarm, etc) without the need to be charged previously by the energy harvester. This is so in case there is an emergency that requires immediate oxygen, the system will be capable of supplying oxygen immediately before the energy harvester 3 can provide the minimum energy needed to activate the PSU target systems. The energy harvester device 3 will continue to charge the energy storage device 5 during the entire flight.

When a decompression event occurs in the aircraft, a pressure sensor 15 reads the cabin pressure P and, if the pressure P is below a specified value for the current elevation, sends a measurement signal 16 to the controller board 7 of the PSU 20. The receipt of the measurement signal 16 triggers the oxygen generation in the oxygen supply regulation system 11, and the door opening mechanism 9. Then the controller board 7 directs the DC current from the energy storage device 5 to power the oxygen supply regulation system 11, initiating flow to an oxygen mask (not shown) available to the passenger. A secondary source of electrical power 25 can also be provided in case of emergencies or other contingencies where the primary power supply fails or is inadequate to handle the required load.

While the embodiment described above is shown for both monitoring the oxygen system and actuating the system, the invention can be used in the two applications individually as well. Thus, the invention serves as a method of powering an oxygen regulation, metering or controller device for an emergency supply of oxygen in an aircraft, as well as an energy harvesting and storage apparatus for said oxygen regulation system. Here, the system only uses energy harvested electricity, and is thus self-powering. The oxygen supply system of an aircraft can be implemented where each breath cycle is supplied with an oxygen dose, and the presence of oxygen flow is indicated by an illuminated signal. The system can also be used with appropriate sensors to detect the concentration presented to the user and the saturation of oxygen of the user. This data/information can then be used to control the variable dispensing of oxygen to crew and passengers. The power generation method can also be utilized in areas throughout the cabin (environmental control systems, air gaspers/ducts, pressurization equipment) to harvest (generate) and store power for the purposes of life support systems.

The present invention enjoys many benefits, including the elimination of the need for secondary power wiring to the PSU or other device/system (e.g., crew mask) for the purpose of gas flow regulation. The present invention also enjoys the benefit of a simpler storage container in the absence of any power connections to the sub-system. The safety of the passengers is also enhanced since there is no power supply adjacent the oxygen supply, and the weight savings due to the elimination of cabling and other components of the electrical system leads to cost savings for the operator of the aircraft.

The foregoing description is intended to be illustrative only, and should not be construed as limited in any manner. Rather, one of ordinary skill in the art would readily envision many variations and modifications, and the scope of the invention is intended to encompass all such modifications and variations. The scope of the invention is properly limited only by the words of the claims below, using their ordinary and customary meanings.

We claim:

1. A method for powering an oxygen regulation, metering, or control device for an aircraft's emergency oxygen supply system, comprising:
providing a passenger safety unit in proximity with a passenger, the passenger safety unit including a flow control device;
connecting a supply of oxygen to the flow control device;
providing an energy harvesting device in proximity with the passenger safety unit, the energy harvesting device converting energy selected from vibration, heat, and light to electrical energy;
storing the electrical energy obtained from the energy harvesting device in an energy storage device; and
powering the flow control device using the energy storage device when said flow control device is needed.

2. The method of claim 1, wherein the energy harvesting device is a piezoelectric converter.

3. The method of claim 1, wherein the energy harvesting device is a thermoelectric converter.

4. The method of claim 1, wherein the energy harvesting device is a photovoltaic converter.

5. The method of claim 1, wherein the flow control device only uses energy from the energy harvesting device.

6. The method of claim 1, wherein a release of oxygen is indicated by an illumination signal.

7. An oxygen flow control system for an aircraft emergency oxygen supply system to a passenger, comprising:
an energy harvesting device for converting environmental energy into electrical energy;
a circuit control board coupled to the energy harvesting device;
an electrical energy storage device for storing electrical energy generated from the energy harvesting device;
a gas pressure sensor for detecting aircraft cabin air pressure;
a passenger safety unit for receiving a signal from the gas pressure sensor, and initiating an oxygen flow to a passenger upon reception of a selected signal from the gas pressure sensor, a control of the flow of the oxygen flow powered by the electrical energy storage device.

8. The oxygen flow control system of claim 7, wherein the energy harvesting device converts vibrational energy to electrical energy.

9. The oxygen flow control system of claim 7, wherein the energy harvesting device converts light energy to electrical energy.

10. The oxygen flow control system of claim 7, wherein the energy harvesting device converts thermal energy to electrical energy.

11. The oxygen flow control system of claim 7, further comprising a supplemental supply of power coupled to the electrical energy storage device.

12. The oxygen flow control system of claim 7, wherein the electrical energy storage device is selected to hold a charge of sufficient magnitude to power the passenger safety unit without further charging.

13. The oxygen flow control system of claim 7, wherein the passenger safety unit includes a controller board that controls a door opening mechanism and directs a power from the electrical energy storage device to a flow control device regulating the flow of oxygen.
